(19) United States
(12) Patent Application Publication
(10) Pub. No.: US 2026/0208269 A1
(43) Pub. Date: Jul. 23, 2026

(54) APPARATUS AND METHOD FOR PRODUCING A THREE-DIMENSIONAL WORK PIECE COMPRISING A FLOW TRAP

(71) Applicant: Nikon SLM Solutions AG, Luebeck (DE)

(72) Inventors: Jan KOPPER, Luebeck (DE); Daniel BRUECK, Luebeck (DE); Daniel STRIEZEL, Luebeck (DE); Naveed IQBAL, Luebeck (DE); Hans Christoph HOHENSEE, Luebeck (DE)

(21) Appl. No.: 19/141,813

(22) PCT Filed: Dec. 18, 2023
(86) PCT No.: PCT/EP2023/086340

§ 371 Date: Jun. 20, 2025

(30) Foreign Application Priority Data
Dec. 23, 2022 (DE) 10 2022 134 769.9

(51) Int. Cl. B22F 12/70; B22F 10/28; B28B 1/00; B33Y 10/00; B33Y 30/00

(52) U.S. Cl. CPC B22F 12/70; B22F 10/28; B28B 1/001; B33Y 10/00; B33Y 30/00; B22F 2998/10

(57) ABSTRACT

An apparatus (10) for producing a three-dimensional work piece comprises a process chamber (12), a carrier (14) configured to receive a raw material powder, an irradiation device (16) configured to selectively irradiate electromagnetic or particle radiation onto the raw material powder on the carrier (14) in order to produce a work piece made of said raw material powder by an additive layer construction method, a transmission element (18) configured to allow the transmission of the electromagnetic or particle radiation emitted by the irradiation device (16) into the process chamber (12), a gas supply device (26) configured to supply gas to the process chamber (12) and comprising at least one gas inlet (28, 32), a gas discharge device (34) configured to discharge gas from the process chamber (12) and comprising at least one gas outlet (36), and a flow trap (44) configured to trap gas containing particulate impurities in a flow trap region (46) which, with respect to a direction of flow (D) of the gas entering the process chamber (12) via the at least one gas inlet (28, 32), is arranged downstream of the transmission element (18).

The present invention relates to an apparatus for producing a three-dimensional work piece by irradiating layers of a raw material powder with electromagnetic or particle radiation. The invention further relates to a method for producing a three-dimensional work piece.

Powder bed fusion is an additive layering process by which pulverulent, in particular metallic and/or ceramic raw materials can be processed to three-dimensional work pieces of complex shapes. To that end, a raw material powder layer is applied onto a carrier and subjected to electromagnetic or particle radiation in dependence on the desired geometry of the work piece that is to be produced. The electromagnetic or particle radiation penetrating into the powder layer causes heating and consequently melting or sintering of the raw material particles. Further raw material powder layers are then applied successively to the layer on the carrier that has already been subjected to radiation treatment, until the work piece has the desired shape and size. Powder bed fusion methods can be used in particular for the production of prototypes, tools, replacement parts or medical prostheses on the basis of CAD data.

Welding smoke generated in a powder bed fusion process upon irradiating and hence melting a raw material powder may contaminate the interior of a process chamber and also components of an irradiation system, such as, for example a lens or window through which a radiation beam is directed into the process chamber. As a result, a gradually increasing part of the radiation energy emitted by the irradiation system may be absorbed by deposited welding smoke condensate material.

An apparatus for producing a three-dimensional workpiece by a powder bed fusion process wherein the absorption of radiation energy emitted by the irradiation system by welding smoke condensate material deposited onto the surface of the transmission element can be reduced is described in EP 3 321 003 B1 . The apparatus according to EP 3 321 003 B1 comprises a process chamber accommodating a carrier for receiving a raw material powder and an irradiation device for selectively irradiating electromagnetic or particle radiation onto the raw material powder on the carrier in order to produce a work piece by an additive layer construction method. A transmission element allows the transmission of the electromagnetic or particle radiation emitted by the irradiation device into the process chamber.

A gas inlet comprises a panel-shaped, gas permeable, porous component which is arranged in a region of a first sidewall of the process chamber. A second sidewall of the process chamber which is arranged opposite the first side wall accommodates a gas outlet. The gas inlet and the gas outlet are configured and arranged in such a manner that a first gas flow of a protective gas stream is generated. The first gas flow has a flow directional component which faces away from the transmission element. A further gas inlet is arranged in the first side wall of the process chamber in a region underneath the gas permeable, porous component of the gas inlet. The further gas inlet and the gas outlet are configured and arranged in such a manner that a second gas flow of the protective gas stream is generated. The second gas flow is directed substantially parallel to the carrier so as to ensure that particulate impurities generated in the process chamber upon irradiating the raw material powder on the carrier with electromagnetic or particle radiation are purged from the process chamber.

The present invention is directed at the object of providing an apparatus and a method for producing a three-dimensional work piece by irradiating layers of a raw material powder with electromagnetic or particle radiation, wherein particularly stable operating conditions during the time of operation can be maintained and thus high-quality work pieces can be produced.

This object is addressed by an apparatus as defined in claim 1 and a method as defined in claim 14.

An apparatus for producing a three-dimensional work piece comprises a process chamber. Further, the apparatus comprises a carrier configured to receive a raw material powder. The carrier may be accommodated in the process chamber. It is, however, also conceivable that the process chamber is movable across the carrier. The carrier may be a rigidly fixed carrier having a surface onto which the raw material powder is applied in order to be subjected to electromagnetic or particle radiation. Preferably, however, the carrier is designed to be displaceable in vertical direction, so that, with increasing construction height of a work piece, as it is built up in layers from the raw material powder, the carrier can be moved downwards in the vertical direction. The raw material powder applied onto the carrier within the process chamber is preferably a metallic powder, in particular a metal alloy powder, but may also be a ceramic powder or a powder containing different materials. The powder may have any suitable particle size or particle size distribution. It is, however, preferable to process powders of particle sizes <100 μm.

The apparatus further comprises an irradiation device configured to selectively irradiate electromagnetic or particle radiation onto the raw material powder on the carrier in order to produce a work piece made of said raw material powder by an additive layer construction method. By means of the irradiation device, the raw material powder applied onto the carrier may be subjected to electromagnetic or particle radiation in a site-selective manner in dependence on the desired geometry of the work piece that is to be produced. The irradiation device may comprise a radiation beam source, in particular a laser beam source, and additionally may comprise an optical unit for guiding and/or processing a radiation beam emitted by the radiation beam source. The optical unit may comprise optical elements such an object lens and a scanner unit, the scanner unit preferably comprising a diffractive optical element and a deflection mirror.

Moreover, the apparatus is provided with a transmission element which is configured to allow the transmission of the electromagnetic or particle radiation emitted by the irradiation device into the process chamber. The transmission element may, for example, be designed in the form of a window. Alternatively, the transmission element may comprise or consist of an optical element, in particular a lens, of the irradiation device.

The material of the transmission element may be selected in dependence on the type of the radiation emitted by the irradiation device in order to ensure the desired transmissibility of the transmission element for the electromagnetic or particle radiation emitted by the irradiation device. Further, the material of the transmission element should be selected in such a manner that the transmission element is capable of withstanding the thermal loads acting on the transmission element during operation of the apparatus for producing a three-dimensional work piece. For example, the transmission element may be made of a glass material or a suitable polymer material. If desired, the transmission element, in the region of a surface facing the interior of the process chamber, may be provided with a surface layer which minimizes the adhesion and deposition of welding smoke condensate onto the surface of the transmission element.

The apparatus is further provided with a gas supply device. The gas supply device is configured to supply gas to the process chamber and comprises at least one gas inlet. Preferably, the gas supply device comprises a first gas inlet which is defined by a panel-shaped, gas permeable, porous component arranged in a region of a first sidewall of the process chamber and a second gas inlet which is arranged in the first side wall of the process chamber in a region underneath the first gas inlet as described, for example, in EP 3 321 003 B1 . The gas supplied by the gas supply device may be an inert gas such as, for example, Argon, Nitrogen or the like. The process chamber may be sealable against the ambient atmosphere in order to be able to maintain a controlled atmosphere therein. The controlled atmosphere may be an inert gas atmosphere in order to prevent undesired chemical reactions, in particular oxidation reactions.

Further, the apparatus comprises a gas discharge device. The gas discharge device is configured to discharge gas from the process chamber and comprises at least one gas outlet. The gas outlet may be arranged in a second sidewall of the process chamber which is arranged opposite to the first side wall accommodating the gas inlet(s).

The gas supply device and the gas discharge device preferably are configured to generate a protective gas stream in the process chamber. In particular, the first gas inlet of the gas supply device and the gas outlet may be configured and arranged in such a manner that a first gas flow of the protective gas stream is generated which has a flow directional component facing away from the transmission element and hence protects the transmission element from being contaminated by impurities, for example powder particles or welding smoke, rising from the raw material powder applied onto the carrier upon being irradiated with electromagnetic or particle radiation. The second gas inlet and the gas outlet may be configured and arranged in such a manner that a second gas flow of the protective gas stream is generated which is directed substantially parallel to the carrier and hence ensures that particulate impurities generated upon irradiating the raw material powder on the carrier with electromagnetic or particle radiation are purged from the process chamber.

A flow cross-sectional area of the at least one gas outlet of the gas discharge device may be smaller than a flow cross sectional area of the process chamber such that a static pressure prevailing in the process chamber is higher than a static pressure prevailing in the gas discharge device downstream of the at least one gas outlet. For example, a static pressure in the process chamber may be around 20 mbar, whereas a static pressure in the gas discharge device downstream of the at least one gas outlet may be <20 mbar.

A recirculation line may connect the gas outlet to the gas inlet(s) so as to allow gas exiting the process chamber via the gas outlet to be recirculated into the process chamber via the gas inlet(s). In order to remove particulate impurities from gas discharged from the process chamber prior to recirculating the gas into the process chamber, a suitable filter arrangement may be provided in the recirculation line.

Further, a suitable conveying device, for example a pump or blower, may be provided in the recirculation line for supplying gas into and for discharging gas from the process chamber.

The apparatus further is equipped with a flow trap which is configured to trap gas containing particulate impurities in a flow trap region. With respect to a direction of flow of the gas entering the process chamber via the at least one gas inlet, the flow trap region is arranged downstream of the transmission element. In the context of the present application, the term “flow trap” defines any device or means which is configured to retain or “trap” gas containing particulate impurities in the flow trap region for a limited or unlimited retention time such that the particulate impurities accumulate in the flow trap region. This may, for example be achieved by a controlled manipulation and/or deceleration of the flow.

Preferably, the flow trap region is arranged in the process chamber, i.e. is defined by a region of the process chamber. For example, the flow trap region may be delimited by a portion of a process chamber wall. It is, however, also conceivable that the flow trap region is arranged outside of the process chamber and that the flow trap is configured to direct or divert gas containing particulate impurities to the flow trap region arranged outside of the process chamber. The apparatus may comprise only one flow trap. It is, however, also conceivable that the apparatus is equipped with a plurality of flow traps which may be arranged at different positions within or with respect to the process chamber.

A stream of gas containing particulate impurities, upon being directed to the flow trap region, might be deflected or diverted from its original main direction of flow. It is, however, also conceivable that the gas containing particulate impurities, upon being directed to the flow trap region maintains its original main direction of flow, but still is finally trapped, i.e. retained in the flow trap region. The flow trap may comprise (a) flow directing, flow deflecting, flow diverting and/or flow retaining element(s) which may be arranged in the process chamber or may be defined by a component or components of the process chamber, for example a process chamber wall or a process chamber wall section. A flow directing, flow deflecting, flow diverting and/or flow retaining element may, however, also comprise or be defined by gas jet or gas stream which influences a stream of gas containing particulate impurities in such a manner that the gas containing particulate impurities is directed to and/or trapped in the flow trap region.

The flow trap prevents that particulate impurities contained in the gas stream downstream of the transmission element reach and hence contaminate the transmission element. In particular, the flow trap ensures that these particulate impurities are retained downstream of the transmission element and prevented from being entrained in the direction of the transmission element, for example by a flow component of the gas stream which rises within the process chamber due heating of the gas when the raw material powder is irradiated and due to the evaporation of raw material from a melt pool generated by the radiation beam impinging on the raw material powder so as to form condensate particles accumulating in the rising flow component of the gas stream.

Thus, the absorption of radiation energy by impurities adhering to the transmission element, for example welding smoke condensate material deposited onto the surface of the transmission element, can be minimized and stable operating conditions can be maintained within the process chamber also during longer times of operation of the apparatus for producing a three-dimensional work piece. As a result, high-quality work pieces can be produced without interrupting the operation of the apparatus for cleaning the transmission element. Furthermore, damages to the transmission element due to the deposition of impurities can be prevented or at least considerably reduced.

While the flow trap region is arranged downstream of the transmission element, components of the flow trap such as, for example, flow guiding or flow deflecting elements may also be provided in a region which, with respect to the direction of flow of the gas entering the process chamber via the at least one gas inlet, is arranged upstream of the transmission element. Further, also the arrangement of components of the flow trap in the region of at least a part of the circumference of the transmission element is conceivable. In addition, components of the flow trap may also be provided at any suitable position within the process chamber.

The flow trap may comprise a shielding element. With respect to the direction of flow of the gas entering the process chamber via the at least one gas inlet, the shielding element may be arranged downstream of the transmission element and may be configured to shield the transmission element from gas containing particulate impurities which is trapped in the flow trap region. Specifically, the shielding element may separate the flow trap region from a region of the process chamber adjacent to the transmission element and hence increase the distance gas and particulate impurities contained therein have to cover for reaching the transmission element.

Further, the shielding element may act as a flow deflecting of flow diverting element which deflects for example a flow component of the gas stream rising within the process chamber in a direction of a top wall of the process chamber in such a manner that the gas and the particulate impurities contained therein are trapped in the flow trap region.

The shielding element may extend from a wall of the process chamber. Alternatively or additionally, the shielding element may comprise a first rim connected to a wall of the process chamber and a second rim arranged opposite to the first rim and facing an interior of the process chamber. The flow trap may comprise only one shielding element. The flow trap may, however, also comprise a plurality of shielding elements which may, for example, surround the flow trap region on different sides thereof.

The shielding element may be inclined with respect to the direction of flow of the gas entering the process chamber via the at least one gas inlet such that the second rim of the shielding element, with respect to the direction of flow of the gas entering the process chamber via the at least one gas inlet, is arranged downstream of the first rim of the shielding element. An inclined shielding element is particularly suitable to retain gas and particulate impurities in the flow trap region downstream of the transmission element.

The shielding element may comprise a substantially plate-shaped element. Alternatively or additionally, the shielding elements may be made of metal, a polymer and/or a mineral material. Preferably, the material of the shielding element is selected so as to ensure that the shielding element is capable of resisting the temperature in the process chamber upon irradiation of the raw material powder without. The shielding device may be provided with a surface which is capable of absorbing and/or reflecting radiation. The surface of the shielding element may, for example, be anodized, coated foiled, oxidized and/or roughened, in particular laser black-marked.

Further, the shielding element may comprise a shielding gas jet. For example, the shielding gas jet may form a kind of gas curtain which extends from the top wall and/or at least one sidewall of the process chamber and which is defined by blowing gas into the process chamber through suitable shielding gas jet inlets formed in the top wall and/or the at least one sidewall of the process chamber.

The shielding element may be formed by an area of a wall of the process chamber, which is arranged offset to the surrounding area of the process chamber wall and thus forms an edge or recess in the process chamber wall.

The transmission element may be arranged in a region of a wall of the process chamber, in particular in a region of the top wall of the process chamber. For example, the transmission element may be integrated into a wall, in particular the top wall of the process chamber. In a particular preferred embodiment of the apparatus, the transmission element is arranged in a region above the carrier in particular a center of the carrier.

The flow trap may be configured to trap gas containing particulate impurities in a flow trap region arranged adjacent to the top wall of the process chamber.

Positioning the flow trap region adjacent to the top wall of the process chamber is particularly advantageous in case the transmission element is arranged in the region of the top wall of the process chamber. The flow trap region may then be delimited by a portion of the process chamber top wall which, with respect to the direction of flow of the gas entering the process chamber via the at least one gas inlet, is arranged downstream of the transmission element. Alternatively or additionally, the flow trap region may be delimited by a portion of the second sidewall, in particular portion of the second sidewall which is arranged above the gas outlet.

In particular in case the transmission element is arranged in the region of the top wall of the process chamber, the shielding element may extend from the top wall of the process chamber and/or the first rim of the shielding element may be connected to the top wall of the process chamber. The second rim of the shielding element may face the carrier for receiving the raw material powder. It is, however, also conceivable that the first rim of the shielding element is connected to a sidewall of the process chamber. For example, the first rim of the shielding element may be connected to the second sidewall of the process chamber above the gas outlet and the second rim of the shielding element may face the first sidewall of the process chamber.

A flow velocity of the gas entering the process chamber via the at least one gas inlet upon flowing through the at least one gas inlet may be higher than a flow velocity of the gas containing particulate impurities when being trapped in the flow trap region. A reduction of the flow velocity of the gas containing particulate impurities is helpful for retaining the gas and in particular the particulate impurities in the flow trap region.

The apparatus preferably further comprises a flow deflection element configured to deflect a flow of gas containing particulate impurities in a direction of the flow trap region and/or a direction of the at least one gas outlet of the gas discharge device. The flow deflection element may form a component of the flow trap, but alternatively may also be designed independent of the flow trap. Preferably, the flow deflection element, with respect to the direction of flow of the gas entering the process chamber via the at least one gas inlet, is arranged downstream of the transmission element.

The flow deflection element may be arranged adjacent to or formed integral with a sidewall of the process chamber. For example, the flow deflection element may be arranged adjacent to a formed integral with the second sidewall of the process chamber. Further, the flow deflection element may be arranged above the at least one gas outlet of the gas discharge device.

The flow defection element may have a rounded and/or bulged structure. For example, the flow deflection element may be defined by or comprise a bent sheet material or may be defined by a bulged portion of a process chamber wall, in particular the second sidewall of the process chamber. The flow deflection element may comprise a first section which is configured to direct a flow of gas containing particulate impurities in the direction of the flow trap region. The first section may comprise a first rim connected to the sidewall of the process chamber. The first section may further comprise a second rim arranged opposite to the first rim and facing an interior of the process chamber. The first section may be inclined with respect to the direction of flow of the gas entering the process chamber via the at least one gas inlet such that the first rim, with respect to the direction of flow of the gas entering the process chamber via the at least one gas inlet, is arranged downstream of the second rim.

Further, the flow deflection element may comprise a second section which is configured to direct a flow of gas containing particulate impurities in the direction of the at least one gas outlet of the gas discharge device. The second section may comprise a first rim connected to the sidewall of the process chamber. The second section may further comprise a second rim arranged opposite to the first rim and facing an interior of the process chamber. The second section may be inclined with respect to the direction of flow of the gas entering the process chamber via the at least one gas inlet such that the first rim, with respect to the direction of flow of the gas entering the process chamber via the at least one gas inlet, is arranged downstream of the second rim.

The flow deflection element may also comprise a third section extending substantially perpendicular to the direction of flow of the gas entering the process chamber via the at least one gas inlet. For example, the third section of the flow deflection element may extend substantially parallel to the sidewall of the process chamber, in particular the second sidewall of the process chamber to which the first section and the second section are connected. Alternatively or additionally, the third section may extend between the second rim of the first section and the second rim of the second section.

The first, the second and/or the third section of the flow deflection element may be arranged adjacent to or formed integral with the sidewall of the process chamber. The flow deflection element may be designed so as to have distinct first, second and third sections. The first, second and third sections of the flow deflection element may, however, also be formed integral with each other and thus merge with each other. For example, the flow deflection element may not contain distinct rims which clearly delimit the sections of the flow deflection element.

The apparatus may further comprise a cooling element configured to cool gas containing particulate impurities which is trapped in the flow trap region. The cooling element may be arranged adjacent to or formed integral with a portion of a process chamber wall which delimits the flow trap region. By cooling the gas containing particulate impurities, deposition of the particulate impurities, for example on the cooling element, is promoted. As a result, the presence of the cooling element enhances the protection of the transmission element from being contaminated by the particulate impurities.

The cooling element may be an active cooling element or a passive cooling element. The cooling element may comprise a cooling channel which may be flown through with a cooling agent such as, for example, water. Alternatively or additionally, the cooling element may comprise or be made of a material having a higher thermal conductivity than a surrounding material. The cooling element may also be provided with cooling fins and/or may have a large surface area in order to allow for a rapid cooling of the trapped gas. The cooled gas typically flows downwards in the direction of the gas outlet and hence away from the transmission element. Further, cooled gas flowing downwards provides room for a “new” smoke/gas cloud to be trapped in the flow trap region.

In a preferred embodiment, the apparatus comprises a removal device configured to remove gas containing particulate impurities from the flow trap region. The removal of particulate impurities from the flow trap region further enhances the protection of the transmission element from being contaminated by the particulate impurities. The removal device may be employed in an apparatus equipped with a flow trap which comprises a shielding element and/or a flow deflection element as described above. It is, however, also conceivable, that the removal device is employed in an apparatus, wherein the flow trap is realized without a shielding element and/or a flow deflection element. Such a flow trap may be defined by or include any device or means which is configured to retain or “trap” gas containing particulate impurities in the flow trap region for a limited or unlimited retention time such that the particulate impurities accumulate in the flow trap region, e.g. by a controlled manipulation and/or deceleration of the flow.

The removal device may comprise a connecting device. A first end of the connecting device may be connected to the flow trap region. Further, the removal device may comprise a conveying device, for example a pump, which is configured to convey gas containing particulate impurities from the flow trap region. The conveying device may be arranged in the connecting device. The connecting device may comprise one or more hose(s). A valve may be arranged in the connecting device so as to enable or disable the removal of gas containing particulate impurities from the flow trap region as required.

A second end of the connecting device may be open or may, for example, be connected to a collecting vessel configured to receive the gas and in particular the particulate impurities removed from the flow trap region. The second end of the connecting device may, however, also be connected to the gas discharge device. For example, the connecting device may connect the flow trap region to a pipe opening into the gas discharge device downstream of the gas outlet. The valve arranged in the connecting device may be configured to enable or disable the removal of gas containing particulate impurities from the flow trap region into the gas discharge device as required.

As already described above, a flow cross-sectional area of the gas outlet may be smaller than a flow cross sectional area of the process chamber such that a static pressure prevailing in the process chamber may be higher than a static pressure prevailing in the gas discharge device downstream of the gas outlet. Therefore, the discharge of gas via the gas outlet may be induced or promoted by the Venturi effect. Further, a flow cross-sectional area of the connecting device may be smaller than a cross-sectional area of the gas discharge device downstream of the at least one gas outlet such that the discharge of gas containing particulate impurities from the flow trap region into the gas discharge device may also be induced or at least promoted by the Venturi effect.

In a method for producing a three-dimensional work piece a layer of raw material powder is applied onto a carrier accommodated in a process chamber. Electromagnetic or particle radiation is selectively irradiated onto the raw material powder on the carrier in order to produce a work piece made of said raw material powder by an additive layer construction method. The electromagnetic or particle radiation is transmitted into the process chamber via a transmission element. Gas is supplied to the process chamber via at least one gas inlet of a gas supply device. Gas is discharged from the process chamber via at least one gas outlet of a gas discharge device. By means of a flow trap, gas containing particulate impurities is trapped in a flow trap region which, with respect to a direction of flow of the gas entering the process chamber via the at least one gas inlet, is arranged downstream of the transmission element.

The flow trap may comprise a shielding element which, with respect to the direction of flow of the gas entering the process chamber via the at least one gas inlet, is arranged downstream of the transmission element and shields the transmission element from gas containing particulate impurities which is trapped in the flow trap region. The flow trap may trap gas containing particulate impurities in a flow trap region arranged adjacent to a/the top wall of the process chamber.

A flow velocity of the gas entering the process chamber via the at least one gas inlet upon flowing through the at least one gas inlet may be higher than a flow velocity of the gas containing particulate impurities when being trapped in the flow trap region. The flow trap may comprise a flow deflection element which deflects a flow of gas containing particulate impurities in a direction of the flow trap region and/or a direction of the at least one gas outlet of the gas discharge device. The flow deflection element may be arranged adjacent to or formed integral with a sidewall of the process chamber, in particular above the at least one gas outlet of the gas discharge device.

The flow deflection element may comprise a first section which directs a flow of gas containing particulate impurities in the direction of the flow trap region. The first section may comprise a first rim connected to the sidewall of the process chamber and a second rim arranged opposite to the first rim and facing an interior of the process chamber. The first section may be inclined with respect to the direction of flow of the gas entering the process chamber via the at least one gas inlet such that the first rim, with respect to the direction of flow of the gas entering the process chamber via the at least one gas inlet, is arranged downstream of the second rim.

Further, the flow deflection element may comprise a second section which directs a flow of gas containing particulate impurities in the direction of the at least one gas outlet of the gas discharge device. The second section may comprise a first rim connected to the sidewall of the process chamber and a second rim arranged opposite to the first rim and facing an interior of the process chamber. The second section may be inclined with respect to the direction of flow of the gas entering the process chamber via the at least one gas inlet such that the first rim, with respect to the direction of flow of the gas entering the process chamber via the at least one gas inlet, is arranged downstream of the second rim.

The flow deflection element may also comprise a third section extending substantially perpendicular to the direction of flow of the gas entering the process chamber via the at least one gas inlet and/or between the second rim of the first section and the second rim of the second section.

In the method for producing a three-dimensional work piece, gas containing particulate impurities may be removed from the flow trap region. A removal device may comprise a connecting device. A first end of the connecting device may be connected to the flow trap region. Gas containing particulate impurities may be removed from the flow trap region by means of a conveying device, for example a pump. A second end of the connecting device may be open or may, for example, be connected to a collecting vessel configured to receive the gas and in particular the particulate impurities removed from the flow trap region. The second end of the connecting device may, however, also be connected to the gas discharge device.

Further features described above with respect to the apparatus for producing a three-dimensional work piece may also be present in the method for producing a three-dimensional work piece.

Preferred embodiments of the invention in the following are explained in greater detail with reference to the accompanying schematic drawings, in which:

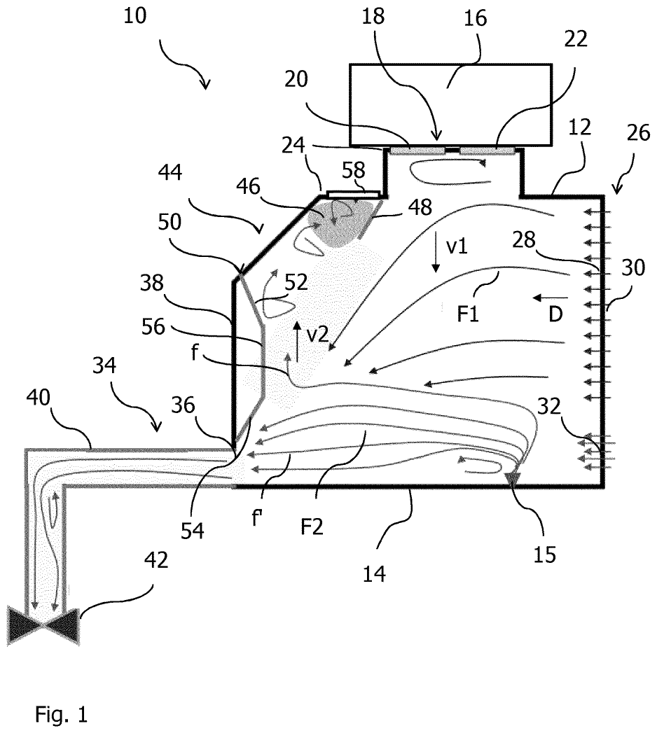

FIG. 1 shows a representation of a first embodiment of an apparatus for producing a three-dimensional work piece, and

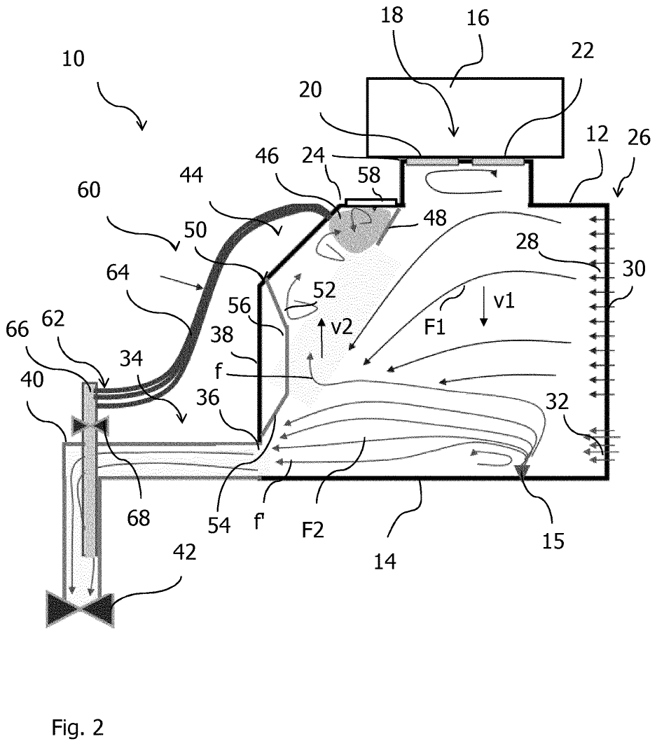

FIG. 2 shows a representation of a second embodiment of an apparatus for producing a three-dimensional work piece.

FIG. 1 shows a first embodiment of an apparatus 10 for producing a three-dimensional work piece by an additive layering process. The apparatus 10 comprises a process chamber 12 accommodating a carrier 14 for receiving a raw material powder. A powder application device 15 serves to apply the raw material powder onto the carrier 14. The carrier 14 is designed to be displaceable in a vertical direction so that, with increasing construction height of a work piece, as it is built up in layers from the raw material powder on the carrier 14, the carrier 14 can be moved downwards in the vertical direction.

The apparatus 10 for producing a three-dimensional work piece further comprises an irradiation device 16 for selectively irradiating electromagnetic or particle radiation, in particular laser radiation onto the raw material powder applied onto the carrier 14 in order to produce a work piece made of said raw material powder by an additive layer construction method. By means of the irradiation device 16, the raw material powder on the carrier 14 may be subjected to electromagnetic or particle radiation in a site selective manner in dependence on the desired geometry of the component that is to be produced. The irradiation device 16 comprises a radiation source which may comprise a diode pumped Ytterbium fiber laser emitting laser light at a wavelength of approximately 1070 to 1080 nm.

The irradiation device 16 further comprises an optical unit for guiding and processing a radiation beam emitted by the radiation source. The optical unit may comprise a beam expander for expanding the radiation beam, a scanner and an object lens.

Alternatively, the optical unit may comprise a beam expander including a focusing optic and a scanner unit. By means of the scanner unit, the position of the focus of the radiation beam both in the direction of the beam path and in a plane perpendicular to the beam path can be changed and adapted. The scanner unit may be designed in the form of a galvanometer scanner and the object lens may be an f-theta object lens.

The apparatus 10 further comprises a transmission element 18 which allows the transmission of the electromagnetic or particle radiation emitted by the irradiation device 16 into the process chamber 12. In the apparatus 10 depicted in the drawings, the transmission element 18 comprises two windows 20, 22 made of glass or a polymeric material which are arranged in a region of a top wall 24 of the process chamber 12 above a center of the carrier 14. Thus, a radiation beam emitted by the irradiation device 16 can be guided through the windows 20, 22 of the transmission element 18 and across the carrier 14 as desired in dependence on the geometry of the work piece to be produced.

The process chamber 12 is sealed against the ambient atmosphere, i.e. against the environment surrounding the process chamber 12. A gas supply device 26 serves to supply gas to the process chamber 12 and comprises a first gas inlet 28 which is defined by a panel-shaped, gas permeable, porous component arranged in a region of a first sidewall 30 of the process chamber 12 and a slit-shaped second gas inlet 32 which is arranged in the first side wall 30 of the process chamber 12 in a region underneath the first gas inlet 28. The gas supplied by the gas supply device 26 may be an inert gas such as, for example, Argon, Nitrogen or the like. The gas is conveyed into the process chamber 12 by means of a suitable conveying device such as, for example, a pump or a blower (not shown).

Further, the apparatus 10 comprises a gas discharge device 34. The gas discharge device 34 serves to discharge gas, in particular gas containing particulate impurities generated in the process chamber 12 upon irradiating the raw material powder on the carrier 14, from the process chamber 12 and comprises a gas outlet 36 which is arranged in a second sidewall 38 of the process chamber 12. The second sidewall 38 of the process chamber 12 is arranged opposite to the first side wall 30.

The gas outlet 36 is connected to a gas discharge line 40 which in turn is connected to the gas supply device 26 via a recirculation line (not shown) so as to allow gas exiting the process chamber 12 via the gas outlet 36 to be recirculated into the process chamber 12 via the first and the second gas inlet 28, 32. In order to remove particulate impurities from gas discharged from the process chamber 12 via the gas outlet 36 prior to recirculating the gas into the process chamber 12, a suitable filter arrangement (not shown) is provided in the recirculation line. The discharge of gas from the process chamber 12 via the gas outlet 36 and the gas discharge line 40 is controlled by a valve 42 which is arranged in the gas discharge line 40.

The gas supply device 26 and the gas discharge device 34 are configured to generate a protective gas stream F1, F2 in the process chamber 12, wherein a first gas flow F1 flows from the first gas inlet 28 gas outlet 36 and a second gas flow F2 flows from the second gas inlet 32 to the gas outlet 36. The supply of gas to the process chamber 12 is controlled in such a manner that a volume flow of gas into the process chamber 12 via the first gas inlet 28, i.e. a volume flow of the first gas flow F1, is larger than a volume flow of gas into the process chamber 12 via the second gas inlet 32, i.e. a volume flow of the second gas flow F2. However, a flow velocity of the first gas flow F1 is smaller than a flow velocity of the second gas flow F2.

The second gas flow F 2, at least in a region of the process chamber 12 adjacent to the second gas inlet 32, is directed substantially parallel to the carrier 14 and hence ensures that particulate impurities generated in the process chamber 12 upon irradiating the raw material powder on the carrier 14 with electromagnetic or particle radiation are purged from the process chamber 12. To the contrary, the first gas flow F1 has a flow directional component v1 facing away from the transmission element 18, i.e. the gas supplied to the process chamber 12 via the first gas inlet 28, upon flowing through the process chamber 12, increases its distance to the top wall 24 of the process chamber 12 accommodating the transmission element 18 after passing the transmission element 18. The first gas flow F1 thus protects the transmission element 18 from being contaminated by impurities, for example powder particles or welding smoke, rising from the raw material powder applied onto the carrier 14 upon being irradiated with electromagnetic or particle radiation.

Since a flow cross-sectional area of the gas outlet 36 is smaller than a flow cross sectional area of the process chamber 12, a static pressure prevailing in the process chamber 12 is higher than a static pressure prevailing in the gas discharge device 34 downstream of the gas outlet 36, for example in the gas discharge line 40. A static pressure in the process chamber 12 may, for example, be around 20 mbar, whereas a static pressure in the gas discharge line 40 may be <20 mbar.

The irradiation of the raw material powder on the carrier 14 introduces heat into the process chamber 12. As a result, the temperature of in particular the second gas flow F 2 increases with increasing distance from the first and the second gas inlet 28, 32. In a region of the process chamber 12 adjacent to the gas outlet 36, the second gas flow F2 therefore has a flow directional component v2 which is directed away from the carrier 14 and towards the top wall 24 of the process chamber 12. The rising gas flow component f typically is loaded with particulate impurities, for example raw material powder particles and/or condensate particles formed due to the evaporation of raw material from a melt pool generated by the radiation beam impinging on the raw material powder.

The apparatus 10 therefore is equipped with a flow trap 44 which is configured to trap gas containing particulate impurities in a flow trap region 46. With respect to the direction of flow D of the gas entering the process chamber 12 via the first and the second gas inlet 28, 32, the flow trap region 46 is arranged in the process chamber 12 downstream of the transmission element 18. The flow trap 44 traps gas containing particulate impurities, in particular the impurity loaded gas flow component f which rises towards the top wall 24 in the region of the gas outlet 36, in the flow trap region 46 for a limited or unlimited retention time such that the particulate impurities accumulate in the flow trap region 46. The flow trap 44 thus prevents that the particulate impurities reach and hence contaminate the transmission element 18.

The flow velocity of the second gas flow F2 entering the process chamber 12 via the second gas inlet 32 upon flowing through the second gas inlet 32 is higher than a flow velocity of the gas containing particulate impurities when being trapped in the flow trap region 46. A reduction of the flow velocity of the gas containing particulate impurities is helpful for retaining the impurity loaded gas in the flow trap region 46. In the apparatus 10 shown in FIG. 1, the flow trap region 46 is arranged in a region of the top wall 24 of the process chamber 12 and hence is delimited by the top wall 24 and a portion of the second sidewall 38 which is connected to the top wall 24.

The portion of the second sidewall 38 which is connected to the top wall 24 and which delimits the flow trap region 46 is inclined with respect to the carrier 14 towards the first sidewall 30. It is, however, also conceivable that the flow trap region 46 is delimited by a portion of the second sidewall 38 which extends substantially perpendicular with respect to the carrier 14 and/or parallel to the first sidewall 30.

The flow trap 44 comprises a shielding element 48 which, with respect to the direction of flow D of the gas entering the process chamber 12 via the first and the second gas inlet 28, 32, is arranged downstream of the transmission element 18 and hence shields the transmission element 18 from gas containing particulate impurities which is trapped in the flow trap region 46. Specifically, the shielding element 48 delimits the flow trap region 46 from a region of the process chamber 12 adjacent to the transmission element 18 and hence increase the distance gas and particulate impurities contained in the flow trap region 46 have to cover for reaching the transmission element 18. Further, the shielding element 48 acts as a flow deflecting of flow diverting element which deflects the rising flow component f of the second gas flow F2 in such a manner that the gas and the particulate impurities contained therein are directed into and finally trapped in the flow trap region 46.

The shielding element 48 comprises a first rim connected to a wall, in particular the top wall 24, of the process chamber 12 and a second rim arranged opposite to the first rim and facing an interior of the process chamber 12. Thus, the shielding element 48 protrudes from a wall, in particular the top wall 24 of the process chamber 12 into the interior of the process chamber 12. Further, the shielding element 48 is inclined with respect to the direction of flow D of the gas entering the process chamber 12 via the first and the second gas inlet 28, 32 such that the second rim of the shielding element 48, with respect to the direction of flow D of the gas entering the process chamber 12 via the first and the second gas inlet 28, 32, is arranged downstream of the first rim of the shielding element 48.

In the arrangement of FIG. 1, the shielding element 48 comprises a substantially plate-shaped element and is made of metal. The shielding element 48 may, however, also be defined by or comprise a shielding gas jet which forms gas curtain extending from a wall, in particular the top wall 24 the process chamber 12 into the interior of the process chamber 12. The shielding gas jet may be defined by blowing gas into the process chamber 12 through suitable shielding gas jet inlets formed in a wall, in particular the top wall 24 of the process chamber 12.

The apparatus 10 further comprises a flow deflection element 50 configured to deflect a flow of gas containing particulate impurities, in particular the impurity loaded gas flow component f which rises towards the top wall 24 in the region of the gas outlet 36, in a direction of the flow trap region 46 and/or a direction of the gas outlet 36 of the gas discharge device 40. With respect to the direction of flow D of the gas entering the process chamber 12 via the first and the second gas inlet 28, 32, is arranged downstream of the transmission element 18. In the apparatus 10 shown in FIG. 1, the flow deflection element 50 is arranged adjacent to a sidewall, in particular the second sidewall 38 of the process chamber 12 above the gas outlet 36. It is, however, also conceivable that the flow deflection element 15 is formed integral with the second sidewall 38.

The flow deflection element 50 comprises a first section 52 which is configured to direct a flow of gas containing particulate impurities, in particular the impurity loaded gas flow component f which rises towards the top wall 24 in the region of the gas outlet 36, in the direction of the flow trap region 46. The first section 52 comprises a first rim connected to the second sidewall 38 of the process chamber 12 and a second rim arranged opposite to the first rim and facing the interior of the process chamber 12. The first section 52 is inclined with respect to the direction of flow D of the gas entering the process chamber 12 via the first and second gas inlet 28, 32 such that the first rim, with respect to the direction of flow D of the gas entering the process chamber 12 via the first and the second gas inlet 28, 32, is arranged downstream of the second rim.

Further, the flow deflection element 50 comprises a second section 54 which is configured to direct a flow of gas containing particulate impurities, in particular a flow component f′ of the second gas flow F2 which, in the region of the gas outlet 36, still flows substantially parallel to the carrier 14, in the direction of the gas outlet 36 of the gas discharge device 40. The second section 54 comprises a first rim connected to the second sidewall 38 of the process chamber 12 and a second rim arranged opposite to the first rim and facing the interior of the process chamber 12. The second section 54 is inclined with respect to the direction of flow D of the gas entering the process chamber 12 via the first and second gas inlet 28, 32 such that the first rim, with respect to the direction of flow D of the gas entering the process chamber 12 via the first and second gas inlet 28, 32, is arranged downstream of the second rim.

The flow deflection element 50 also comprises a third section 56 extending substantially perpendicular to the direction of flow D of the gas entering the process chamber 12 via the first and second gas inlet 28, 32 and substantially parallel to the second sidewall 38 of the process chamber 12. Further, the third section 56 extends between the second rim of the first section 52 and the second rim of the second section 54.

The flow defection element 50 may be replaced by a second flow trap region. Further, the flow deflection element 50 may have a rounded and/or bulged structure. For example, the flow deflection element 50 may be defined by or comprise a bent sheet material or may be defined by a bulged portion of the second sidewall 38 of the process chamber 12.

The apparatus 10 also comprises a cooling element 58 which is configured to cool gas containing particulate impurities which is trapped in the flow trap region 46. In the apparatus 10 of FIG. 1, the cooling element 58 is integrated into a portion of the top wall 24 of the process chamber wall 12 which delimits the flow trap region 46.

FIG. 2 shows a second embodiment of an apparatus 10 for producing a three-dimensional work piece by an additive layering process which differs from the arrangement of FIG. 1 in that the apparatus 10 shown in FIG. 2 comprises a removal device 60 which serves to remove gas containing particulate impurities from the flow trap region 46. The removal device 60 comprises a connecting device 62. A first end of the connecting device 62 is connected to the flow trap region 46. The removal device 60 may also comprise a conveying device (not shown), for example a pump, which is configured to convey gas containing particulate impurities from the flow trap region 46. The conveying device may be arranged in the connecting device 62.

A second end of the connecting device 62 may be open or may, for example, be connected to a collecting vessel (not shown) configured to receive the gas and in particular the particulate impurities removed from the flow trap region 46. In the arrangement of FIG. 2, the second end of the connecting device 62 is, however, connected to the gas discharge device 32. In particular, the connecting device 62 comprises one or more hose(s) 64 which connect the flow trap region 46 to a pipe 66 opening into the gas discharge device 40 downstream of the gas outlet 36. The connecting device 62 may, however, also comprise other means for connecting the flow trap region 46 to the gas discharge device 40, e.g. a bypass channel routed along the second sidewall 38. Specifically, the pipe 66 opens into the gas discharge line 40 downstream of the gas outlet 36.

A valve 68 is arranged in the connecting device 62, in particular the pipe 66, so as to enable or disable the removal of gas containing particulate impurities from the flow trap region 46 into the gas discharge device 36 as required. A flow cross-sectional area of the connecting device 62 is smaller than a cross-sectional area of the gas discharge device 36 downstream of the gas outlet 36, i.e. the gas discharge line 14, such that the discharge of gas containing particulate impurities from the flow trap region 46 into the gas discharge device 36 may be induced or at least promoted by the Venturi effect. A length of the pipe 66 may be selected so as to increase the pressure difference between the connecting device 62 and the gas discharge device 36 downstream of the gas outlet 36 and so as to compensate for a potential stall at the edge of the pipe 66.

Otherwise the structure and the function of the apparatus 10 shown in FIG. 2 correspond to the structure and the function of the apparatus 10 according to FIG. 1.

In FIG. 2, the removal device 60 is employed in an apparatus 10 equipped with a flow trap 44 which comprises a shielding element 48 and a flow deflection element 50. It is, however, also conceivable, that the removal device 60 is employed in an apparatus 10, wherein the flow trap 44 is realized without a shielding element 48 and/or a flow deflection element 50, but with another suitable means which is configured to retain or “trap” gas containing particulate impurities in the flow trap region 46, e.g. by a controlled manipulation and/or deceleration of the flow.

1-19. (canceled)

20. An apparatus for producing a three-dimensional work piece, the apparatus comprising:
a process chamber,
a carrier configured to receive a raw material powder,
an irradiation device configured to selectively irradiate electromagnetic or particle radiation onto the raw material powder on the carrier in order to produce a work piece made of said raw material powder by an additive layer construction method,
a transmission element configured to allow the transmission of the electromagnetic or particle radiation emitted by the irradiation device into the process chamber,
a gas supply device configured to supply gas to the process chamber and comprising at least one gas inlet,
a gas discharge device configured to discharge gas from the process chamber and comprising at least one gas outlet, and
a flow trap configured to trap gas containing particulate impurities in a flow trap region which, with respect to a direction of flow of the gas entering the process chamber via the at least one gas inlet, is arranged downstream of the transmission element.

21. The apparatus according to claim 20,
wherein the flow trap comprises a shielding element which, with respect to the direction of flow of the gas entering the process chamber via the at least one gas inlet, is arranged downstream of the transmission element and is configured to shield the transmission element from gas containing particulate impurities which is trapped in the flow trap region.

22. The apparatus according to claim 21, wherein the shielding element extends from a wall of the process chamber and/or comprises a first rim connected to a wall of the process chamber and a second rim arranged opposite to the first rim and facing an interior of the process chamber.

23. The apparatus according to claim 22, wherein the shielding element is inclined with respect to the direction of flow of the gas entering the process chamber via the at least one gas inlet such that the second rim of the shielding element, with respect to the direction of flow of the gas entering the process chamber via the at least one gas inlet, is arranged downstream of the first rim of the shielding element.

24. The apparatus according to claim 21,
wherein the shielding element comprises at least one of:
a substantially plate-shaped element; and
a shielding gas jet.

25. The apparatus according to claim 20,
wherein:
the transmission element is arranged in a top wall of the process chamber, and/or
the flow trap is configured to trap gas containing particulate impurities in a flow trap region arranged adjacent to the top wall of the process chamber, and/or
the shielding element extends from the top wall of the process chamber and/or the first rim of the shielding element is connected to the top wall of the process chamber.

26. The apparatus according to claim 20,
wherein:
a flow velocity of the gas entering the process chamber via the at least one gas inlet upon flowing through the at least one gas inlet is higher than a flow velocity of the gas containing particulate impurities when being trapped in the flow trap region.

27. The apparatus according to claim 20, further comprising a flow deflection element configured to deflect a flow of gas containing particulate impurities in a direction of the flow trap region and/or a direction of the at least one gas outlet of the gas discharge device.

28. The apparatus according to claim 27,
wherein the flow deflection element is arranged adjacent to or formed integral with a sidewall of the process chamber, in particular above the at least one gas outlet of the gas discharge device.

29. The apparatus according to claim 27, wherein the flow deflection element comprises at least one of:
a first section which is configured to direct a flow of gas containing particulate impurities in the direction of the flow trap region and which in particular comprises a first rim connected to the sidewall of the process chamber and a second rim arranged opposite to the first rim and facing an interior of the process chamber, wherein the first section is inclined with respect to the direction of flow of the gas entering the process chamber via the at least one gas inlet such that the first rim, with respect to the direction of flow of the gas entering the process chamber via the at least one gas inlet, is arranged downstream of the second rim, and/or
a second section which is configured to direct a flow of gas containing particulate impurities in the direction of the at least one gas outlet of the gas discharge device and which in particular comprises a first rim connected to the sidewall of the process chamber and a second rim arranged opposite to the first rim and facing an interior of the process chamber, wherein the second section is inclined with respect to the direction of flow of the gas entering the process chamber via the at least one gas inlet such that the first rim, with respect to the direction of flow of the gas entering the process chamber via the at least one gas inlet, is arranged downstream of the second rim, and/or
a third section (56) extending substantially perpendicular to the direction of flow of the gas entering the process chamber via the at least one gas inlet and/or between the second rim of the first section and the second rim of the second section.

30. The apparatus according to claim 20, further comprising a cooling element configured to cool gas containing particulate impurities which is trapped in the flow trap region.

31. The apparatus according to claim 20, further comprising:
a removal device configured to remove gas containing particulate impurities from the flow trap region.

32. The apparatus according to claim 31,
wherein the removal device comprises a connecting device connecting the flow trap region to the gas discharge device.

33. A method for producing a three-dimensional work piece, the method comprising:
applying a layer of raw material powder onto a carrier,
selectively irradiating electromagnetic or particle radiation onto the raw material powder on the carrier in order to produce a work piece made of said raw material powder by an additive layer construction method,
transmitting the electromagnetic or particle radiation into a process chamber via a transmission element,
supplying gas to the process chamber via at least one gas inlet of a gas supply device,
discharging gas from the process chamber via at least on gas outlet of a gas discharge device, and
by means of a flow trap, trapping gas containing particulate impurities in a flow trap region which, with respect to a direction of flow of the gas entering the process chamber via the at least one gas inlet, is arranged downstream of the transmission element.

34. The method according to claim 33,
wherein:
the flow trap comprises a shielding element which, with respect to the direction of flow of the gas entering the process chamber via the at least one gas inlet, is arranged downstream of the transmission element and shields the transmission element from gas containing particulate impurities which is trapped in the flow trap region, and/or
the flow trap traps gas containing particulate impurities in a flow trap region arranged adjacent to a top wall of the process chamber.

35. The method according to claim 33,
wherein:
a flow velocity of the gas entering the process chamber via the at least one gas inlet upon flowing through the at least one gas inlet is higher than a flow velocity of the gas containing particulate impurities when being trapped in the flow trap region.

36. The method according to claim 33, wherein the flow trap comprises a flow deflection element which deflects a flow of gas containing particulate impurities in a direction of the flow trap region and/or a direction of the at least one gas outlet of the gas discharge device, wherein the flow deflection element in particular is arranged adjacent to or formed integral with a sidewall of the process chamber, in particular above the at least one gas outlet of the gas discharge device.

37. The method according to claim 36,
wherein the flow deflection element comprises at least one of:
a first section which directs a flow of gas containing particulate impurities in the direction of the flow trap region and which in particular comprises a first rim connected to the sidewall of the process chamber and a second rim arranged opposite to the first rim and facing an interior of the process chamber, wherein the first section is inclined with respect to the direction of flow of the gas entering the process chamber via the at least one gas inlet such that the first rim, with respect to the direction of flow of the gas entering the process chamber via the at least one gas inlet, is arranged downstream of the second rim, and/or
a second section which directs a flow of gas containing particulate impurities in the direction of the at least one gas outlet of the gas discharge device and which in particular comprises a first rim connected to the sidewall of the process chamber and a second rim arranged opposite to the first rim and facing an interior of the process chamber, wherein the second section is inclined with respect to the direction of flow of the gas entering the process chamber via the at least one gas inlet such that the first rim, with respect to the direction of flow of the gas entering the process chamber via the at least one gas inlet, is arranged downstream of the second rim, and/or
a third section (56) extending substantially perpendicular to the direction of flow of the gas entering the process chamber via the at least one gas inlet and/or between the second rim of the first section and the second rim of the second section.

38. The method according to claim 33, further comprising:
removing gas containing particulate impurities from the flow trap region, wherein a removal device in particular comprises a connecting device connecting the flow trap region to the gas discharge device.
